(19) United States
(12) Patent Application Publication
(10) Pub. No.: US 2025/0202083 A1
(43) Pub. Date: Jun. 19, 2025

(54) Battery Pack and Battery System

(71) Applicant: Andreas Stihl AG & Co. KG, Waiblingen (DE)

(72) Inventors: Christian UHLMANN, Uttenreuth (DE); Daniel SAUERTEIG, Kernen im Remstal (DE)

(21) Appl. No.: 18/988,103

(22) Filed: Dec. 19, 2024

(30) Foreign Application Priority Data
Dec. 19, 2023 (DE) 10 2023 135 808.1

(51) Int. Cl. H01M 50/583; H01M 50/342; H02J 7/00

(52) U.S. Cl. CPC H01M 50/583; H01M 50/3425; H02J 7/0044; H01M 2220/30

(57) ABSTRACT

A battery pack for detachable electrical connection to a battery-based device, wherein the battery pack has: at least one substantially cylindrical electric battery cell for storing electrical energy, and a current-limiting device, which is designed so as to be separate from the at least one battery cell and is electrically connected to the battery cell, for limiting an electric current flowing between the at least one battery cell and the battery-based device. The at least one battery cell has a cell interior and a differential pressure valve, wherein the differential pressure valve is designed to automatically connect the cell interior to an external environment of the battery cell so as to equalize pressure if a pressure difference prevailing between the cell interior and the external environment exceeds a predetermined limit value. The at least one battery cell itself has no current-interrupting device and/or no current-limiting device.

### CROSS REFERENCE TO RELATED APPLICATION

This application claims priority under 35 U.S.C. § 119 from German Patent Application No. 102023135808.1, filed Dec. 19, 2023, the entire disclosure of which is herein expressly incorporated by reference.

### BACKGROUND AND SUMMARY

The invention relates to a battery pack for detachable electrical connection to a battery-based device. The invention additionally relates to a battery system having such a battery pack.

The object of the present invention is to provide a battery pack for detachable electrical connection to a battery-based device, and a battery system having such a battery pack, which, in particular each, have improved properties.

This object is achieved by the subject matter of the independent claims. Preferred embodiments are the subject matter of the dependent claims.

An, in particular electric, battery pack according to the invention is intended for detachable electrical, in particular and detachable mechanical, connection to a battery-based device. The battery pack can be designed for use in a battery system comprising the battery pack and the battery-based device. The battery pack is designed in particular to store electrical energy.

The battery pack has at least one substantially cylindrical electric battery cell for storing electrical energy. In addition, the battery pack has a current-limiting device, in particular at least, for limiting an electric current flowing between the at least one battery cell and the battery-based device, wherein the current-limiting device is designed so as to be separate from the at least one battery cell and is, in particular directly or indirectly, electrically connected to the battery cell. In particular, the current-limiting device and the at least one battery cell are designed so as to be structurally non-uniform. The at least one battery cell and the current-limiting device can be designed so as to be physically separate from one another and/or be arranged physically separately, in particular at a distance from one another. In particular, the current-limiting device is arranged outside of the at least one battery cell. Preferably, the electric current can be limited by means of the current-limiting device if an internal and/or external electrical short circuit of the battery pack is present and—alternatively or in addition—if a temperature of the battery pack exceeds a predetermined temperature value and—alternatively or in addition—if the internal pressure exceeds a predetermined pressure value, in particular wherein the battery pack has a sensor device, which is connected to the current-limiting device for control purposes, for detecting the short circuit and/or the temperature and/or the internal pressure.

The at least one battery cell has a cell interior and a differential pressure valve. In this case, the differential pressure valve is designed to automatically connect the cell interior to an external environment of the battery cell so as to equalize pressure if a pressure difference prevailing between the cell interior and the external environment exceeds a predetermined limit value.

The at least one battery cell itself has no current-limiting device and—alternatively or in addition—no current-interrupting device. The current-limiting device of the battery pack can thus be accessible, for example for repair and/or maintenance purposes of the battery pack, without this requiring access to the at least one battery cell. This can bring about advantages from a sustainability perspective. The at least one battery cell can be particularly expensive in terms of production and/or procurement. Separating the current-limiting device from the battery cell allows the current-limiting device to be realized in particular without influencing the battery cell, if required.

Preferably, the differential pressure valve is not designed to limit and—alternatively or in addition—to interrupt the electric current.

Preferably, the pressure difference corresponds to a difference between an internal pressure prevailing in the cell interior and an environmental pressure prevailing in the external environment. In particular, the differential pressure valve is designed exclusively to connect the cell interior to the external environment so as to equalize pressure. In particular, the differential pressure valve is designed to connect the cell interior to the external environment so as to equalize pressure if, in particular only if, the internal pressure is greater than the environmental pressure. In this respect, the differential pressure valve can thus act as an overpressure valve. In particular, the differential pressure valve is designed to irreversibly connect the cell interior to the external environment so as to equalize pressure, i.e. the differential pressure valve is not able to be closed again after it has been opened and/or is destroyed as it is opened.

“Substantially cylindrical” can in the present context take into account a presence of a chamfer and—alternatively or in addition—a rounding on an, in particular circumferential and/or edge-like, transition between an end face of the substantially cylindrical battery cell and a lateral surface of the battery cell. Alternatively or in addition, “substantially cylindrical” can take into account a presence of an unevenness and/or profiling of at least one of the end faces of the battery cell. “Substantially cylindrical” can take into account a spherical shape, in particular of the lateral surface.

“Substantially cylindrical” can in the present context, in particular alternatively or in addition, relate to the shape of a general cylinder. It is thus conteplated for the substantially cylindrical battery cell to have, for example, a substantially prismatic, in particular cuboidal, shape. Preferably, the substantially cylindrical battery cell has a substantially circular cylindrical shape. The substantially circular cylindrical battery cell can synonymously be referred to as a “battery round cell”. In particular, the substantially cylindrical battery cell is not a pouch cell.

Preferably, the at least one battery cell has no current interrupt device (CID). In particular, such a CID is present as a current-interrupting device, in particular integrally and/or non-removably, in customary battery round cells. The CID of customary battery round cells is designed in particular to irreversibly limit, in particular interrupt, the electric current, i.e. as a result of the CID being triggered for one-time limiting of the current, the CID loses its function and/or becomes irreversibly damaged. In particular, in the case of customary battery cells, triggering of the, in particular inseparable, integrated CID results in the entire battery cell becoming unusable and/or irreversibly damaged and so the entire customary battery cell then needs to be replaced. In this respect, dispensing with an integrated CID can have an advantageous effect on the sustainability of the battery pack, in particular because the entire at least one battery cell does not therefore need to be replaced after the electric current has been limited. Dispensing with a CID of the battery cell can additionally have an advantageous effect on an electric battery-cell impedance of the battery cell.

It is conteplated for the battery pack to be able to have at least or exactly one battery cell without a CID and at least or exactly one other battery cell with a CID. Preferably, however, none of the battery cells of the battery pack has a CID.

The term “configured” or “set up” can be used synonymously for the term “designed”.

The term “comprises” can be used synonymously for the term “has”.

“Control” in the present context can mean “regulate”, in particular in a close-loop or in an open-loop manner.

The phrase “and—alternatively or in addition—” can be substitutable synonymously by “and/or”.

Preferably, the current-limiting device is arranged in an electrical plus path and—alternatively or in addition-in an electrical minus path of the battery pack. The current-limiting device can thus be arranged either only in the plus path or only in the minus path or both in the minus path and in the plus path.

Preferably, the current-limiting device can, in particular alternatively or in addition, be arranged in an electrical connection path of the battery pack, wherein the electrical connection path connects at least two battery cells of the battery pack to one another.

Preferably, the connection path can electrically connect at least two bundles of battery cells to one another, in particular wherein the connection path is used to electrically connect the bundles in parallel or in series. The battery cells belonging to a bundle can be electrically connected in series or in parallel with one another within the bundle.

Preferably, the at least one battery cell has a cell housing which delimits the cell interior together with the differential pressure valve. If the differential pressure valve is closed, the cell interior can be separated fluid-tightly from the external environment by means of the cell housing and by means of the closed differential pressure valve.

Preferably, the external environment of the battery cell is present in a housing interior of the battery pack, which housing interior is surrounded by a battery pack housing of the battery pack. In particular, the housing interior communicates with an atmosphere surrounding the outside of the battery pack, so as to conduct fluid and—alternatively or in addition—to equalize pressure.

Preferably, the current-limiting device can have a housing, in particular its own housing, wherein the housing of the current-limiting device and the cell housing of the at least one battery cell are designed so as to be materially non-uniform and/or physically different from one another. The battery pack housing of the battery pack can form and/or, in particular integrally, comprise the housing of the current-limiting device.

In one configuration of the invention, the at least one battery cell has an electric battery-cell impedance. In this case, when an electric AC current is applied at an AC current frequency of 1 kHz at an electrical state of charge (SOC) of the battery cell of 50% and at a temperature of the battery cell of 20° C. to 25° C., a value of the battery-cell impedance is less than 10 mΩ (milliohms). In particular, only a real part, in particular and not the imaginary part, of the battery-cell impedance is taken into account for the value of the battery-cell impedance. In particular, when the AC current is applied at the AC current frequency of 1 kHz at an electrical state of charge of 50% and at a temperature of 20° C. to 25° C., the value of the electric battery-cell impedance is in particular less than 5 mΩ more particularly less than or equal to 3 mΩ.

In particular, when an electric AC current is applied at an AC current frequency of 1 kHz at an electrical state of charge of the battery cell of 50% and at a temperature of the battery cell of 20° C. to 25° C., the value of the electric battery-cell impedance of the battery cell is greater than 0.1 mΩ, in particular greater than 0.5 mΩ, in particular greater than 1 mΩ, in particular greater than 2 mΩ.

Preferably, the state of charge of 50% can be ascertained as follows: The battery cell can be charged to a predetermined nominal voltage, in particular defined by the manufacturer, wherein the nominal voltage corresponds to the state of charge of 50%. Alternatively or in addition, the battery cell can be initially completely electrically discharged or charged in order to then charge or discharge exactly 50% of the capacity of the battery cell such that the state of charge of 50% is reached and/or set. It goes without saying that other and/or combined ascertainment methods may be expedient.

Preferably, the battery-cell impedance can be ascertained as follows: An electric AC current can be impressed on the battery cell at a fixed AC current frequency of 1 kHz, wherein the AC voltage response of the battery cell resulting from the impression is measured. In this case, “impress” can be understood to be synonymous with “apply”. The battery-cell impedance, in particular its value, arises as AC current resistance (z=u/i) from the ratio of the measured AC voltage u to the AC current i.

In a further configuration of the invention, the current-limiting device is designed so as to be removable from the battery cell and—alternatively or in addition—to be interchangeable, in particular for repair purposes.

In a further configuration of the invention, the at least one battery cell is in the form of a multi-tab cell having at least one, in particular wound, multi-tab electrode and—alternatively or in addition—is in the form of a tabless cell having at least one, in particular wound, tabless electrode.

Preferably, the tabless cell, in particular in the form of a tabless round cell, can be designed according to US 2020/0144676 A1. The tabless cell can synonymously be referred to as an “endless tab cell” having at least one endless tab electrode and—alternatively or in addition—as an “earless tab cell” having at least one earless tab electrode and—alternatively or in addition—as an “ear-free cell” having at least one ear-free electrode and—alternatively or in addition—as a “continuous tab cell” having at least one continuous tab electrode and—alternatively or in addition—as a “full tab cell” having at least one full tab electrode.

Preferably, battery cells can generally have two wound electrodes, in particular separated from one another, in particular in a sandwich-like manner, by means of a separator of the respective battery cell. Here, in the case of a battery cell which in particular is not designed as a tabless cell and/or multi-tab cell, at least one of the electrodes can have on one of their axial ends in particular integral connection portions (“tabs”), arranged separated from one another at a distance, for electrically connecting this electrode to one of two cell-contact portions of the relevant battery cell. In this case, the connection portions arranged separated from one another at a distance can form constrictions for an electric current flowing between the relevant electrode and the relevant cell-contact portion, which can cause a relatively large battery-cell impedance of such battery cells. In particular, the two cell-contact portions are oppositely electrically polarized in a state of the battery cell in which it is charged with electrical energy. In the state of the battery cell in which it is charged with electrical energy, a voltage can thus be present at the two cell-contact portions. A respective cell-contact portion can be formed by a disc-shaped and/or cap-shaped contact element of the battery cell.

Preferably, the tabless cell, in particular in contrast to a battery cell which is not in the form of a tabless cell, can have at least one, in particular wound, tabless electrode, wherein the tabless electrode has on one of its axial ends only a single, in particular integral connection portion which-alternatively or in addition-extends around a winding axis of the tabless electrode, in particular in the manner of a spiral, over the entire extent of the tabless electrode, for electrically connecting this tabless electrode to the relevant one of the two cell-contact portions. The tabless electrode thus in particular does not have more than one connection portion.

Preferably, a multi-tab electrode of a multi-tab cell-in particular in contrast to the tabless electrode of the tabless cell-can have a multiplicity of connection portions, in particular arranged directly one after another, which are each in particular radially bent in such a way that two adjacent ones of the connection portions touch one another and—alternatively or in addition—overlap one another.

It goes without saying that hybrid forms of battery cells, in which, for example, the two electrodes belong to different electrode types, are Preferably conteplated. In some circumstances, it can even be conteplated for a single one of the electrodes to belong to different electrode types, for example if its axial ends are formed differently.

In a further configuration of the invention, the at least one battery cell has an axial cell height and a cell diameter measured perpendicularly to the cell height. The cell diameter can be 10 mm to 30 mm. Alternatively or in addition, the cell height can be 40 mm to 78 mm.

In a further configuration of the invention, the current-limiting device is designed to reversibly limit the electric current flowing between the at least one battery cell and the battery-based device. Alternatively or in addition, the current-limiting device can be designed to reversibly limit an electric short-circuit current flowing as a result of an internal and/or external short circuit of the battery pack. Reversibly limiting the electric current can have an advantageous effect on the sustainability of the battery pack, in particular because reversibly limiting the current does not involve, in particular permanent, deactivation of and/or damage to the current-limiting device and so the current-limiting device retains its function, in particular automatically, after the current has been limited in order to remain usable for a subsequent limiting of the current.

Preferably, the current-limiting device designed to reversibly limit the electric current has in particular at least or exactly one electronic semi-conductor switch, in particular a MOSFET, for controlled interruption of the electric current. Alternatively or in addition, the current-limiting device has in particular at least or exactly one thermally triggerable switch, in particular having a bimetal element, for controlled interruption of the electric current. Alternatively or in addition, the current-limiting device has in particular at least or exactly one magnetically triggerable switch, in particular having a switching mechanism and having an electric coil for magnetically actuating the switching mechanism, for controlled interruption of the electric current. Alternatively or in addition, the current-limiting device has in particular at least or exactly one connectable electrical resistor element for limiting the electric current. Alternatively or in addition, the current-limiting device has in particular at least or exactly one PTC resistor element, in particular i.e. an electrical PTC thermistor, for limiting the electric current.

In a further configuration of the invention, the current-limiting device is designed to irreversibly limit the electric current flowing between the at least one battery cell and the battery-based device. Alternatively or in addition, the current-limiting device can be designed to irreversibly limit an electric short-circuit current flowing as a result of an internal and/or external short circuit of the battery pack.

Preferably, the current-limiting device designed to irreversibly limit the current has at least one, in particular replaceable or non-replaceable, electrical fusible-conductor element for interrupting the electric current. Alternatively or in addition, the current-limiting device can have a severing device for irreversibly interrupting the electric current. The severing device can be designed to irreversibly sever an electrically conductive busbar of the battery pack, which busbar is electrically connected to the at least one battery cell. The severing device can have a cartridge in which a chemical reaction takes place above a certain temperature and which (irreversibly) severs the busbar by increasing pressure. Alternatively or in addition, it is conteplated for the chemical reaction to be triggerable electrically, in particular by the electric current and/or by an electric leakage current, and/or pressure-dependently.

In a further configuration of the invention, the current-limiting device is designed to automatically interrupt the, in particular internal and/or external, electrical short circuit of the battery pack. In particular, the current-limiting device is designed to interrupt the short circuit if the electrical short circuit is present between electrical connection contacts of the battery pack for detachable electrical connection to the battery-based device. The short circuit can be present outside the housing interior as an external short circuit. Alternatively or in addition, the short circuit can be present inside the housing interior of the battery pack as an internal short circuit. Alternatively or in addition, the short circuit can be present inside the cell interior and/or outside the cell interior of the at least one battery cell.

Preferably, the current-limiting device is designed-in particular alternatively or in addition to limiting the short-circuit current-to limit an electric switch-on current which, for example, flows for a period of time directly after the battery-based device electrically connected to the battery pack has been switched on and—alternatively or in addition—directly after the battery pack has been electrically connected to the battery-based device. The period of time can be dependent on various parameters. The period of time can be predetermined and—alternatively or in addition—temperature-dependent and—alternatively or in addition—ageing-dependent and—alternatively or in addition-dependent on a state of charge of the battery pack.

In a further configuration of the invention, the battery pack has a number of, in particular identically designed, battery cells. In particular, in this case each one of the battery cells itself has no integrated current-interrupting device and—alternatively or in addition—no integrated current-limiting device. In other words: In particular, none of the battery cells has an integrated current-interrupting device and—alternatively or in addition—an integrated current-limiting device.

Preferably, the number of battery cells can be at least or exactly 1. The number can be more than one. The number of battery cells can be 1 to 500, in particular 3 to 200. If the number is greater than 1, the battery cells can be arranged in an electrical series connection, in particular in bundles, and—alternatively or in addition—in an electrical parallel connection, in particular in bundles.

In a further configuration of the invention, the current-limiting device is designed to limit the electric current flowing between the battery pack and the battery-based device, in particular entirely and—alternatively or in addition—across cells. In particular, one and the same current-limiting device is designed to limit the electric current flowing between the battery pack and the battery-based device, in particular entirely and/or across cells. The battery pack can thus have only a single current-limiting device for all its battery cells. However, it is alternatively conteplated for the battery pack to have a plurality of current-limiting devices, in particular wherein one current-limiting device is provided for each bundle of battery cells and/or for each battery cell. The plurality of current-limiting devices of the battery pack can be controllable by means of an, in particular central and/or electronic, control device of the battery pack.

A battery system according to the invention has an, in particular electrical, battery pack according to the invention according to the preceding description. Advantages of the battery pack according to the invention are thus also transferred to the battery system according to the invention. In addition, the battery system comprises an, in particular electrical, battery-based device. In this case, the battery-based device is able to be or is detachably electrically connected, in particular and detachably mechanically connected, to the interchangeable electrical battery pack.

Preferably, the battery-based device has a reception device which is designed to be substantially complementary to the battery pack and is designed to interchangeably receive the battery pack and for the associated detachable electrical connection of the battery pack to the battery-based device.

In one configuration of the invention, the electrical battery-based device is in the form of an electrical machining device, wherein the electrical machining device is able to be operated by means of electrical energy from the battery pack. Alternatively or in addition, the battery-based device is in the form of an electrical charging device for charging the interchangeable battery pack with electrical energy that is to be stored.

Preferably, the battery-based device in the form of a machining device is a machining device which is ground-guided and/or hand-guided, in particular handheld, and/or carried on the back and/or a garden, forest, ground and/or construction machining device. The machining device can be designed to be able to be guided by hand, that is to say in particular a machining direction of the machining device is able to be adjusted by a user's hand guiding the machining device, relative to a workpiece currently being machined by means of the machining device. In particular, the machining device can be a saw, in particular a chainsaw, or a pole pruner, or hedge shears, or a hedge cutter, or a wood cutter, or branch shears, an angle grinder or a blowing device, or a leaf blower, or a suction device, or a leaf suction device, or a cleaning device, or a high-pressure cleaner, or a sweeping device, or a sweeping roller, or a sweeping brush, or a lawnmower, or grass shears, or a brush cutter, or a scarifier. In addition or alternatively, the machining device can have a machining tool and/or an, in particular electric, drive motor, in particular for driving the machining tool. The drive motor can be able to be supplied with electrical energy from the battery pack, in particular in order to provide drive power for the machining tool.

Preferably, the battery-based device in the form of a charging device has an electrical power-supply connection for electrical connection to an electrical energy source, for example to an electrical supply grid. The charging device can be used to charge the received battery pack with electrical energy from the energy source. The charging device can have an electronic charging controller.

It goes without saying that the battery-based device in the form of a machining device can have an electrical power-supply connection for electrical connection to an electrical energy source, for example to an electrical supply grid, in order to charge the battery pack with electrical energy from the electrical energy source. In this respect, the battery-based device can be designed to have the dual function of both a machining device and a charging device.

Further advantages and features of the invention emerge from the claims and from the following description of preferred exemplary embodiments of the invention which are illustrated by the drawings. In this case, identical reference signs relate to identical or similar or functionally identical components.

It goes without saying that the features mentioned above and the features that are still to be explained below cannot only be used in the respectively specified combination but also in other combinations or by themselves without leaving the scope of the present invention.

### BRIEF DESCRIPTION OF THE DRAWINGS

FIG. 1 is a structural diagram of one embodiment of a battery pack according to the invention;

FIG. 2 is a schematic side view of a further embodiment of the battery pack according to the invention;

FIG. 3 is a schematic perspective illustration of a battery-based device in the form of an electrical charging device for one embodiment of a battery system according to the invention; and

FIG. 4 is a schematic side view of one embodiment of the electrical battery system according to the invention having a battery-based device in the form of an electrical machining device and having the battery pack according to FIG. 2.

### DETAILED DESCRIPTION OF THE DRAWINGS

An, in particular electrical, battery pack 1 is provided for a battery system 30. The battery pack 1 is thus designed, for example, for use in the battery system 30.

The battery system 30 has the battery pack 1. In addition, the battery system 30 has an, in particular electrical, battery-based device 40. The battery pack 1 is designed for detachable electrical connection to the battery-based device 40. In the present case, the battery pack 1 is additionally designed for detachable mechanical connection to the battery-based device 40. The battery-based device 40 has, for example, a reception device which is designed to be substantially complementary to the battery pack and is designed to interchangeably receive the battery pack 1 and for the associated detachable electrical connection of the battery pack 1 to the battery-based device 40.

The battery-based device 40 is, for example, in the form of an electrical machining device 41 (shown in FIG. 4) which is able to be supplied with electrical energy by means of the received battery pack 1. Alternatively or in addition, the electrical battery-based device 40 is in the form of an electrical charging device 42 (shown in FIG. 3) for electrically charging the received battery pack 1.

The machining device 41 shown in FIG. 4 is an electrical motorized chainsaw. The machining device 41 has, for example, a machining tool-in the present case in the form of a saw chain. Alternatively or in addition, the machining device 41 can have an, in particular electric, drive motor which can be used to drive the machining tool. For example, the drive motor is able to be supplied with electrical energy from the received battery pack 1 in order to provide drive power for the machining tool.

The battery-based device 40 in the form of a charging device 42 has, for example, a power-supply connection for electrical connection to an electrical energy source, for example in the form of an electrical supply grid. The charging device 42 can be used, for example, to charge the received battery pack 1 with electrical energy from the energy source. The charging device 42 can have an electronic charging controller.

It goes without saying that the battery-based device 40 in the form of a machining device 41 can have an electrical power-supply connection-not shown in the present case-for electrical connection to an electrical energy source, for example in the form of an electrical supply grid, in order to charge the received battery pack 1 with electrical energy from the electrical energy source. In this respect, the battery-based device 40 can be designed to have the dual function of both a machining device 41 and a charging device 42.

The battery pack 1 has at least one substantially cylindrical electrical battery cell 2. The battery cell 2 is designed to store electrical energy. The battery cell 2 can have two electrical cell-contact portions which are oppositely electrically polarized if the battery cell 2 is charged with electrical energy. The cell-contact portions can each have a cap-like and/or disc-shaped design. In the present case, the at least one battery cell 2 is in the form of a substantially circular cylindrical battery cell 2, that is to say in the form of a battery round cell. The cell-contact portions can have and/or form axially opposite end faces of the battery cell 2.

For example, the at least one battery cell 2 has an electric battery-cell impedance. In this case, when an electric AC current is applied at an AC current frequency of 1 kHz at an electrical state of charge of the battery cell 2 of 50% and at a temperature of the battery cell 2 of 20° C. to 25° C., a value of the battery-cell impedance is, for example, less than 10 mΩ. The value of the electric battery-cell impedance can be less than 5 mΩ, more particularly less than or equal to 3 mΩ. The value of the electric battery-cell impedance can be greater than 0.1 mΩ, in particular greater than 0.5 mΩ, in particular greater than 1 mΩ, in particular greater than 2 mΩ.

The battery cell 2 is, for example, in the form of a multi-tab cell 7 having at least one, in particular wound, multi-tab electrode 8. Alternatively or in addition, the battery cell 2 is, for example, in the form of a tabless cell 9 having at least one, in particular wound, tabless electrode 10. The tabless electrode 10 can have on at least one of its axial ends only a single connection portion (“tab”), which in particular is integral and/or which extends around a winding axis of the tabless electrode 10 over the entire extent of the tabless electrode 10, for electrically connecting the tabless electrode 10 to an associated one of the two cell-contact portions of the battery cell 2, in particular inside the cell interior 4. In the present case, the tabless electrode 10 thus does not have more than one connection portion. In contrast to the tabless electrode 10 of the tabless cell 9, the multi-tab electrode 8 of the multi-tab cell 7 can have a multiplicity of connection portions, in particular arranged directly one after another, which are, for example, radially bent in such a way that two adjacent ones of the connection portions touch one another and/or overlap one another. It goes without saying that hybrid forms of battery cells 2 are conteplated.

For example, the battery cell 2 has an axial cell height H. In the present case, the battery cell 2 additionally has a cell diameter D measured perpendicularly to the cell height H. In this case, the cell diameter D is, for example, 10 mm to 30 mm. Alternatively or in addition, the cell height H is-as in the present case −40 mm to 78 mm.

The battery pack 1 has a current-limiting device 3 for limiting an electric current flowing between the at least one battery cell 2 and the battery-based device 40. The current-limiting device 3 can be designed to limit an electric short-circuit current which can flow as a result of an internal electrical short circuit and/or an external electrical short circuit of the battery pack 1.

The battery pack 1 has, for example, electrical connection contacts 22, which are in particular external and/or exposed in the state of the battery pack 1 in which the latter is not connected to the battery-based device 40 and which are designed for detachable electrical connection to the battery-based device 40. In this case, the electrical short circuit of the battery pack 1 can be present between the connection contacts 22. An external short circuit is present in particular outside a housing interior 24 surrounded by a battery-pack housing 23 of the battery pack 1. An internal electrical short circuit can be present in particular inside a cell interior 4 of the battery cell 2 between the cell-contact portions of the at least one battery cell 2 and/or inside the housing interior 24. The current-limiting device 3 is designed, for example, to automatically interrupt the electrical short circuit of the battery pack 1.

The current-limiting device 3 of the battery pack 1 is designed to be separate from the at least one battery cell 2. In particular, the current-limiting device 3 is designed to be separate from all the battery cells 2 of the battery pack 1. The current-limiting device 3 is electrically connected to the at least one battery cell 2. For example, the current-limiting device 3 is arranged outside the battery cell 2, in particular outside the cell interior 4.

The current-limiting device 3 is, for example, designed to reversibly limit the electric current flowing between the at least one battery cell 2 and the battery-based device 40. In this case, the current-limiting device 3 can have—as in the present case—an electronic semi-conductor switch 12, for example a MOSFET 13, for controlled interruption of the electric current.

Alternatively or in addition, the current-limiting device 3 can have—as in the present case—a thermally triggerable switch 14, in particular having a bimetal element 15, for controlled interruption of the electric current.

Alternatively or in addition, the current-limiting device 3 can have—as in the present case—a magnetically triggerable switch 16, wherein the switch 16 has in particular a switching mechanism 17 and an electric coil 18 for magnetically actuating the switching mechanism 17. The magnetically triggerable switch 16 can be designed for controlled interruption of the electric current.

Alternatively or in addition, the current-limiting device 3 can have—as in the present case—a connectable electrical resistor element 19 for limiting the electric current.

Alternatively or in addition, the current-limiting device 3 can have—as in the present case—a PTC resistor element 20 for limiting the electric current.

The current-limiting device 3 can alternatively or—as in the present case—in addition be designed to irreversibly limit the electric current flowing between the at least one battery cell 2 and the battery-based device 40. In this case, the current-limiting device 3 can have an, in particular replaceable or non-replaceable, electrical fusible-conductor element 21 for interrupting the electric current. Alternatively or in addition, the fusible-conductor element 21 can be integrated in an electrically conductive busbar of the battery pack 1 and/or in an electrically conductive cell-connecting device of the battery pack 1.

The current-limiting device 3 can, for example, as in the present case, be designed to be at least partially functionally redundant both for reversibly and for irreversibly limiting the electric current flowing between the at least one battery cell 2 and the battery-based device 40. For example, the current-limiting device 3 can be designed to irreversibly limit the current to a first limit value and to reversibly limit the current to a second limit value, in particular wherein the amount of the second limit value is less than that of the first limit value. The battery pack 1 can have a current-limiting cascade which can be realized in the above way, for example.

In the present case, the current-limiting device 3 is arranged both in an electrical plus path PP and in an electrical minus path MP of the electrical battery pack 1. In other embodiments, the current-limiting device 3 can be arranged either exclusively in the plus path PP or exclusively in the minus path MP of the electrical battery pack 1.

Alternatively or in addition, the current-limiting device 3 can be arranged in an electrical connection path VP of the battery pack 1, wherein the electrical connection path VP connects at least two battery cells 2 of the battery pack 1 to one another.

The connection path VP can electrically connect at least two bundles of battery cells 2, in particular wherein the bundles are electrically connected in parallel or in series by means of the connection path VP. The battery cells 2 belonging to a bundle can be electrically connected in series or in parallel with one another in particular within the bundle. The connection path VP runs along the electrically conductive cell-connecting device.

One of the connection contacts 22 is, for example, present in the minus path MP while the other of the connection contacts 22 is present in the plus path PP.

For example, the current-limiting device 3 is designed so as to be removable from the at least one battery cell 2. Alternatively or in addition, the current-limiting device 3 can be designed so as to be interchangeable, in particular in modular fashion. This can be advantageous with regard to the maintenance and—alternatively or in addition—repair of the battery pack 1, in particular if the current-limiting device 3 needs to be substituted.

The at least one battery cell 2 of the battery pack 1 itself has no current-limiting device. Alternatively or in addition, the at least one battery cell 2 has no current-interrupting device. In other words: The battery cell 2 itself is in particular free of any current-interrupting device and—alternatively or in addition—free of any current-limiting device.

In the present case, the at least one battery cell 2 has no “current interrupt device (CID)”, as is present in customary battery cells. In particular, none of the battery cells 2 of the battery pack 1 has a CID.

The at least one battery cell 2 has a differential pressure valve 5. In this case, the differential pressure valve 5 is designed to automatically connect the cell interior 4 to an external environment U of the battery cell 2 so as to equalize pressure if a pressure difference prevailing between the cell interior 4 and the external environment U exceeds a predetermined limit value. The limit value can in particular be predetermined by the structural design of the differential pressure valve 5. The differential pressure valve 5 is in particular not a CID.

For example, the pressure difference corresponds to a difference between an internal pressure pᵢ prevailing in the cell interior 4 and an environmental pressure p_{U} prevailing in the external environment U. In this case, the differential pressure valve 5 can be designed exclusively to connect the cell interior 4 to the external environment U so as to equalize pressure. In the present case, the differential pressure valve 5 is designed to connect the cell interior 4 to the external environment U so as to equalize pressure if the internal pressure pᵢ is greater than the environmental pressure p_{U}. In the present case, the differential pressure valve 5 thus acts as an overpressure valve for releasing a differential pressure that exceeds the predetermined limit value from the cell interior 4.

For example, the differential pressure valve 5 is designed to irreversibly connect the cell interior 4 to the external environment U so as to equalize pressure, i.e. the differential pressure valve 5 is, for example, not able to be closed again. Alternatively or in addition, the differential pressure valve 5 is destroyed as it is opened.

The differential pressure valve 5 can have a valve body and a valve seat which, in a closed state, are connected, in particular materially uniformly and/or fluid-tightly, at least in regions by means of a defined breaking point of the differential pressure valve. In order to open the differential pressure valve 5, the connection of the valve body and of the valve seat can be separated at the defined breaking point in a differential-pressure-dependent manner such that a valve opening of the differential pressure valve 5 arises, which valve opening connects the cell interior 4 to the environment U so that they can communicate. In particular, the differential pressure valve 5 is arranged, in particular integrally, on one of the cell-contact portions of the battery cell 2.

For example, the differential pressure valve 5 is not designed for limiting and—alternatively or in addition—not for interrupting the electric current flowing in particular between the cell-contact portions. The differential pressure valve 5 is thus in particular not a CID.

In the present case, the at least one battery cell 2 has a cell housing 6 which delimits the cell interior 4 together with the differential pressure valve 5. If the differential pressure valve 5 is closed, the cell interior 4 can be separated fluid-tightly from the external environment U by means of the cell housing 6 and by means of the closed differential pressure valve 5. The cell-contact portions are in particular constituent parts of the cell housing 6. In particular, the differential pressure valve 5 can open the cell interior 4 in a manner dependent on the differential pressure before the differential pressure causes the cell housing 6 to undesirably burst open and/or tear open, in particular away from the cell-contact portions and/or away from the differential pressure valve 5.

The at least one battery cell 2 and—alternatively or in addition—the current-limiting device 3 is/are, for example, housed by the battery-pack housing 23 of the battery pack 1. The external environment U of the battery cell 2 can be present in the housing interior 24 of the battery pack 1, which housing interior is surrounded by the battery-pack housing 23. In this case, the housing interior 24 in the present case communicates with an atmosphere A surrounding the outside of the battery pack 1, so as to conduct fluid and—alternatively or in addition—to equalize pressure.

For example, the battery pack 1 has a number of, in particular identically designed, battery cells 2. For example, the number of battery cells 2 can be 1 to 500, in particular 3 to 200. In particular, all the battery cells 2 are identically designed, that is to say in particular all the battery cells 2 can be of the same type. For example, the battery cells 2 are designed to be geometrically and/or functionally identical.

It goes without saying that the battery pack 1 can have a further electrical energy storage device and/or battery which is different, in particular geometrically and/or functionally, from the at least one battery cell 2. Such a further electrical energy storage device and/or battery can, for example, be used to supply electrical energy to an electronic display of the battery pack 1 for displaying a battery-pack state, in particular the state of charge of the at least one battery cell 2, if and/or only for as long as the state of charge of the at least one battery cell 2 is not enough to operate the display.

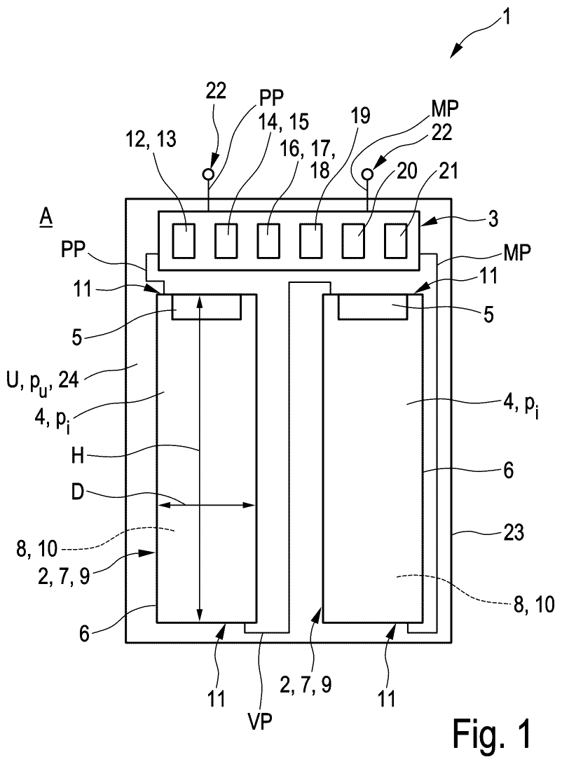

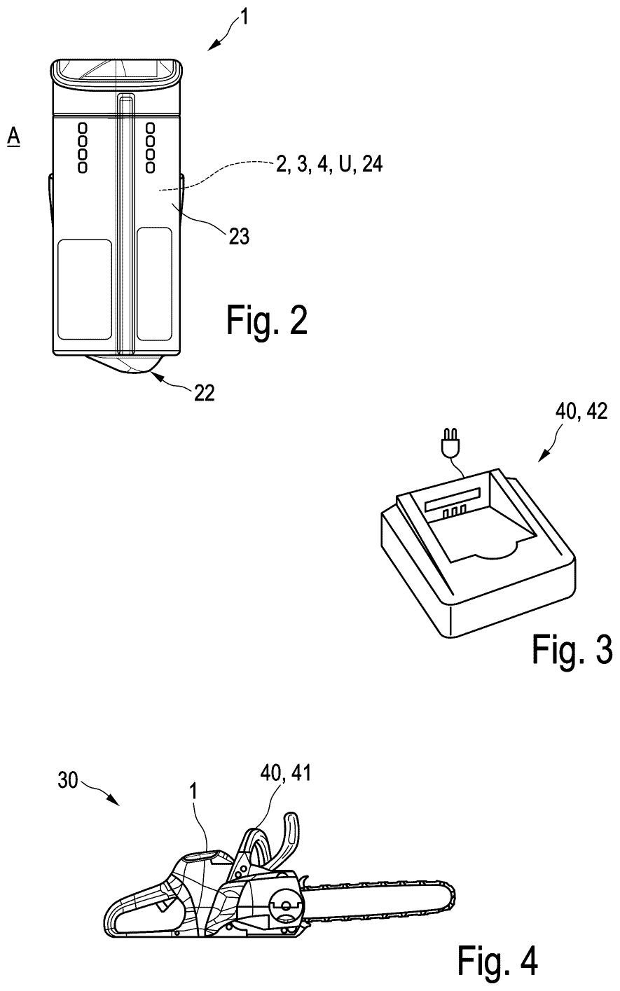

The illustration of FIG. 1 shows, for example, two battery cells 2 of the battery pack 1, wherein the two battery cells 2 are electrically connected in series. The battery pack 1 can have further battery cells 2 which are electrically connected in parallel with the battery cells 2 which can be seen in FIG. 1. Embodiments which exclusively have battery cells 2 electrically connected in parallel are also conteplated.

In the present case, one and the same current-limiting device 3 is designed to limit the electric current flowing between the battery pack 1 and the battery-based device 40 and—alternatively or in addition—as a result of an electrical short circuit of the battery pack 1. In this case, the current-limiting device 3 can be designed to limit, completely and/or across cells, the electric current flowing between the battery pack 1 and the battery-based device 40. The battery cells 2 can thus share the current-limiting device 3.

In the present case, none of the battery cells 2 has its own integrated current-interrupting device and/or its own integrated current-limiting device.

It is conteplated for at least two of the battery cells 2 to each be assigned a current-limiting device 3 of the battery pack 1, wherein the at least two current-limiting devices 3 are designed to be separate from the battery cells 2. The current-limiting devices 3 can be controlled by means of an, in particular central, electronic control device of the battery pack 1, in particular in order to limit the electric current for each battery cell 2 and/or across cells.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A battery pack for detachable electrical connection to a battery-based device, the battery pack comprising:
at least one substantially cylindrical electric battery cell for storing electrical energy; and
a current-limiting device, which is designed so as to be separate from the at least one battery cell and is electrically connected to the battery cell, for limiting an electric current that flows between the at least one battery cell and the battery-based device,
wherein the at least one battery cell has a cell interior and a differential pressure valve,
wherein the differential pressure valve is designed to automatically connect the cell interior to an external environment of the battery cell so as to equalize pressure if a pressure difference prevailing between the cell interior and the external environment exceeds a predetermined limit value, and
wherein the at least one battery cell itself has no current-interrupting device and/or no current-limiting device.

2. The battery pack according to claim 1,
wherein the at least one battery cell has an electric battery-cell impedance,
wherein, when an electric AC current is applied at an AC current frequency of 1 kHz at an electrical state of charge of the battery cell of 50% and at a temperature of the battery cell of 20° C. to 25° C., a value of the battery-cell impedance is less than 10 mΩ.

3. The battery pack according to claim 1,
wherein the current-limiting device is designed so as to be removable from the battery cell and/or to be interchangeable.

4. The battery pack according to claim 1,
wherein the at least one battery cell is a multi-tab cell having at least one wound, multi-tab electrode or is a tabless cell having at least one wound, tabless electrode.

5. The battery pack according to claim 1,
wherein the at least one battery cell has an axial cell height and a cell diameter measured perpendicularly to the axial cell height,
wherein the cell diameter is 10 mm to 30 mm and/or the axial cell height is 40 mm to 78 mm.

6. The battery pack according to claim 1, wherein
the current-limiting device is designed to reversibly limit the electric current flowing between the at least one battery cell and the battery-based device,
wherein the current-limiting device comprises at least one of:
an electronic semi-conductor switch for controlled interruption of the electric current,
a thermally triggerable switch having a bimetal element for controlled interruption of the electric current,
a magnetically triggerable switch, having a switching mechanism and an electric coil for magnetically actuating the switching mechanism, for controlled interruption of the electric current,
a connectable electrical resistor element for limiting the electric current, or a PTC resistor element for limiting the electric current.

7. The battery pack according to claim 1,
wherein the current-limiting device is designed to irreversibly limit the electric current flowing between the at least one battery cell and the battery-based device,
wherein the current-limiting device has an electrical fusible-conductor element for interrupting the electric current.

8. The battery pack according to claim 1,
wherein the current-limiting device is designed to automatically interrupt an electrical short circuit of the battery pack, if the electrical short circuit is present between electrical connection contacts of the battery pack for detachable electrical connection to the battery-based device.

9. The battery pack according to claim 1,
wherein the battery pack has a number of identically designed, battery cells,
wherein each one of the battery cells itself has no integrated current-interrupting device and/or integrated current-limiting device.

10. The battery pack according to claim 1,
wherein the current-limiting device is designed to limit the electric current flowing between the battery pack and the battery-based device, entirely and/or across cells.

11. A battery system, comprising:
a battery pack according to claim 1; and
a battery-based device which is detachably electrically connectable to the interchangeable electrical battery pack.

12. The battery system according to claim 11,
wherein the battery-based device is an electrical machining device which is able to be operated via electrical energy from the battery pack, and/or
wherein the battery-based device is an electrical charging device for charging the interchangeable battery pack with electrical energy that is to be stored.
